(19) United States
(12) Patent Application Publication
(10) Pub. No.: US 2009/0089827 A1
(43) Pub. Date: Apr. 2, 2009

(54) SYSTEM FOR SPECIFIC SCREEN-AREA TARGETING FOR PARENTAL CONTROL VIDEO BLOCKING

(75) Inventors: Eric Stephen Carlsgaard, Zionsville, IN (US); Mark Gilmore Mears, Zionsville, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD, Shenzhen (CN)

(21) Appl. No.: 11/865,382

(22) Filed: Oct. 1, 2007

(51) Int. Cl. H04N 7/16

(52) U.S. Cl. 725/28

(57) ABSTRACT

There is provided a system and/or method of displaying video content. More specifically, in one embodiment, there is provided a method comprising receiving input regarding a type of potentially objectionable video content (POC) that is to be filtered when displaying video content, receiving a video signal containing an indication of a display location of POC in the video content and a type of POC at that display location, and filtering display of content identified by the indication of the display location of the POC and the type of the POC if the type of POC corresponds to the type of POC that is to be filtered when displaying the video content.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Known parental control systems for live or broadcast television may use ratings information about entire programs to permit a parent to either allow the entire program to be viewed or block the entire program based on an indication that the program contains potentially objectionable content (POC). In addition, closed caption data may be monitored during television broadcasts so that objectionable scenes and audio data may be suppressed based on parental control settings. In the area of video playback, such as viewing video data stored on DVDs, some known systems provide data regarding when to skip certain video scenes or mute audio of certain portions of the program based on parental control settings. An improved parental control system is desired.

### BRIEF DESCRIPTION OF THE DRAWINGS

### In the Drawings:

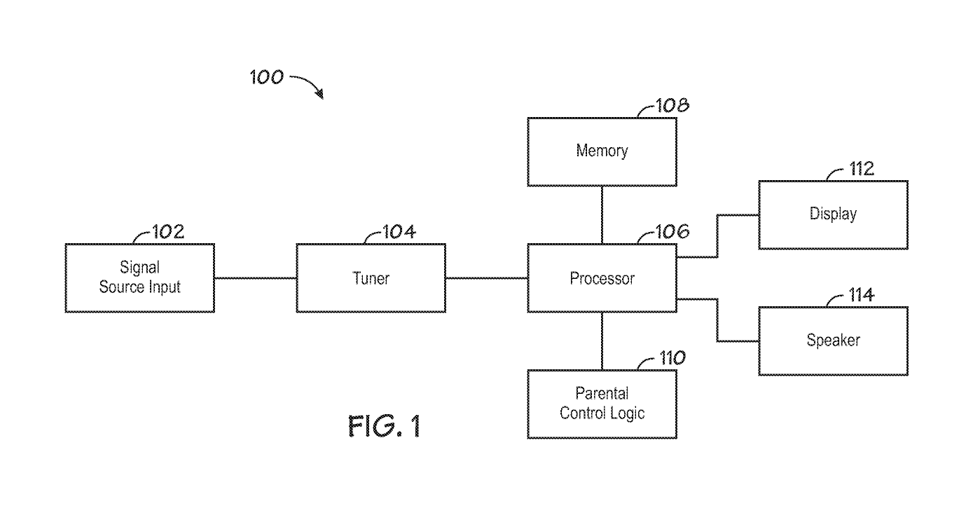

FIG. 1 is a block diagram of an electronic device that may employ a parental control system in accordance with an exemplary embodiment of the present invention;

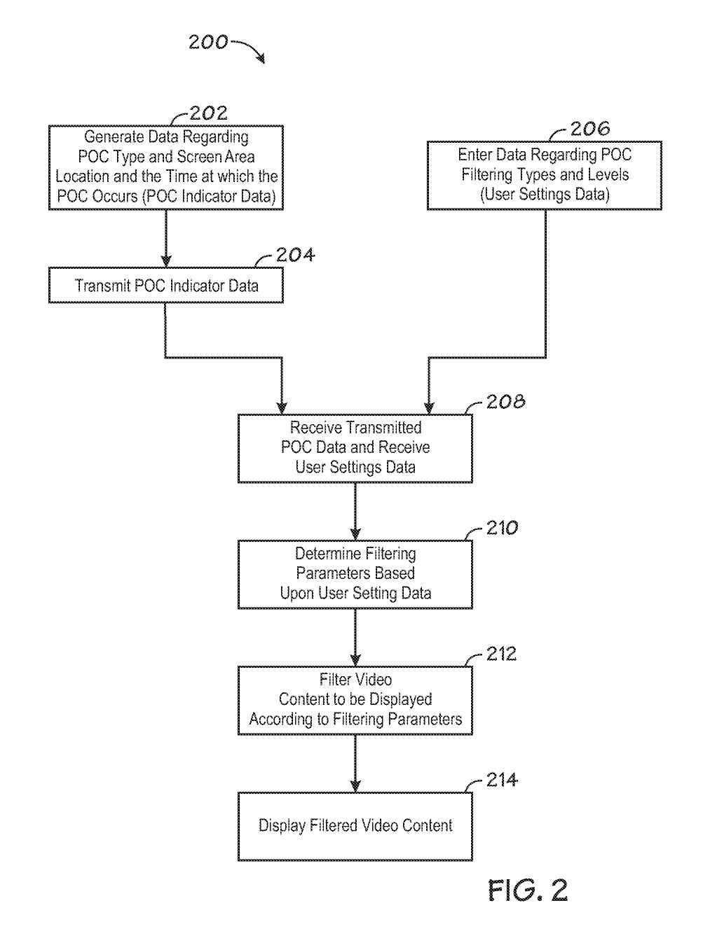

FIG. 2 is a process flow diagram in which the display of POC is filtered in a scenario involving broadcast television in accordance with an exemplary embodiment of the present invention;

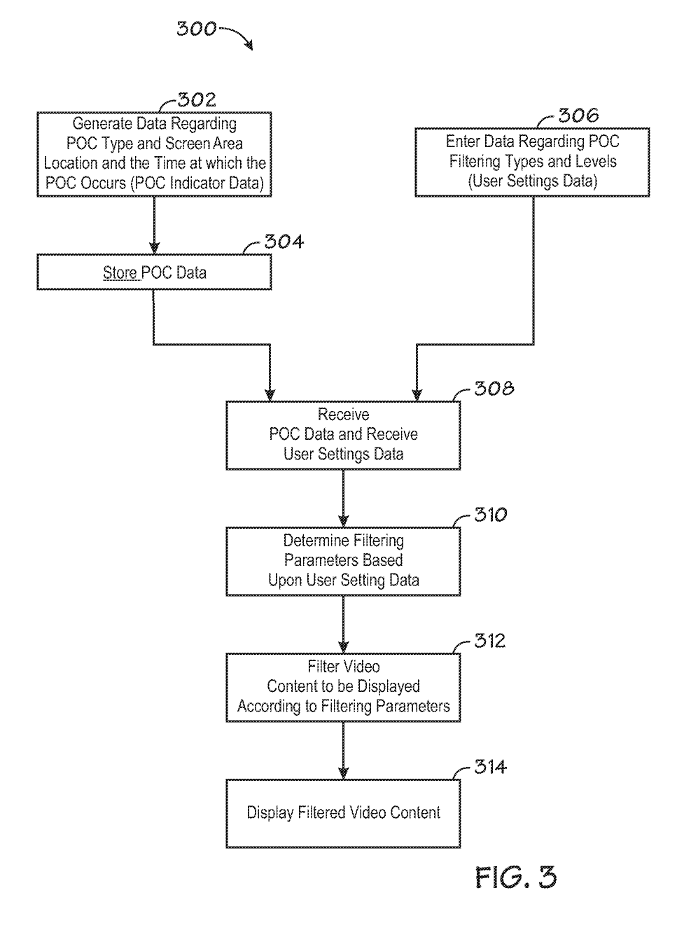

FIG. 3 is a process flow diagram in which the display of POC is filtered in a scenario involving stored media content in accordance with an exemplary embodiment of the present invention;

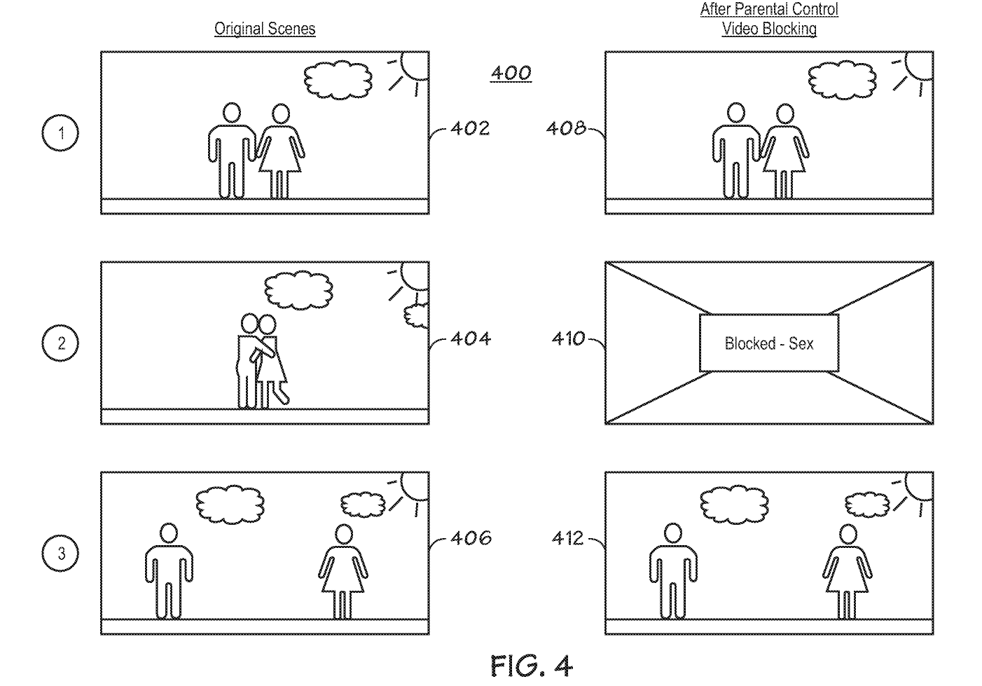

FIG. 4 is a diagram depicting video content before and after the application of heavy filtering of POC in accordance with an exemplary embodiment of the present invention;

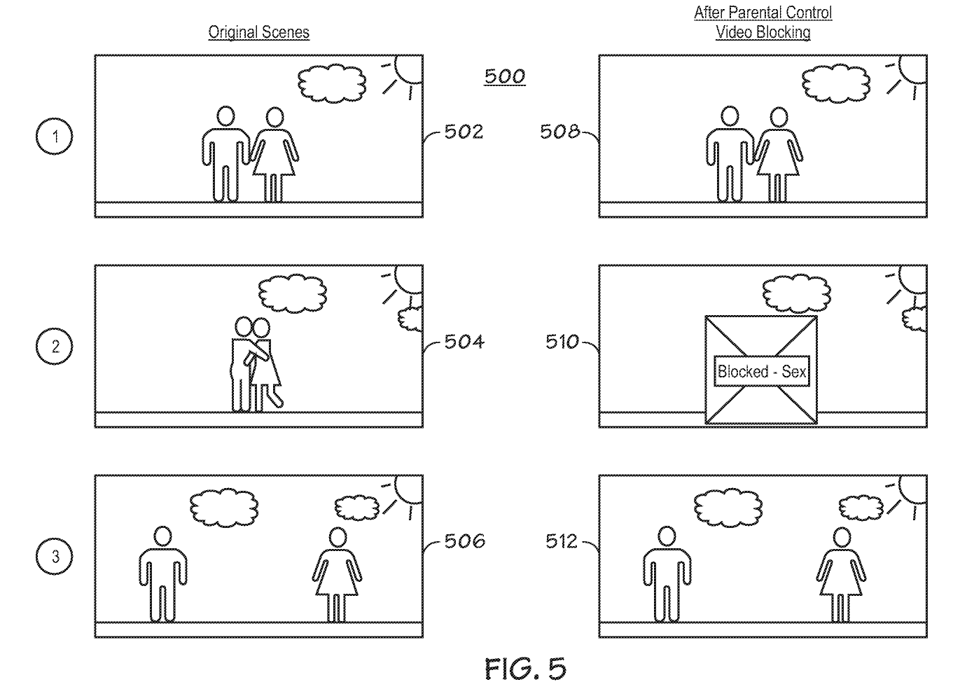

FIG. 5 is a diagram depicting video content before and after the application of medium filtering of POC in accordance with an exemplary embodiment of the present invention; and

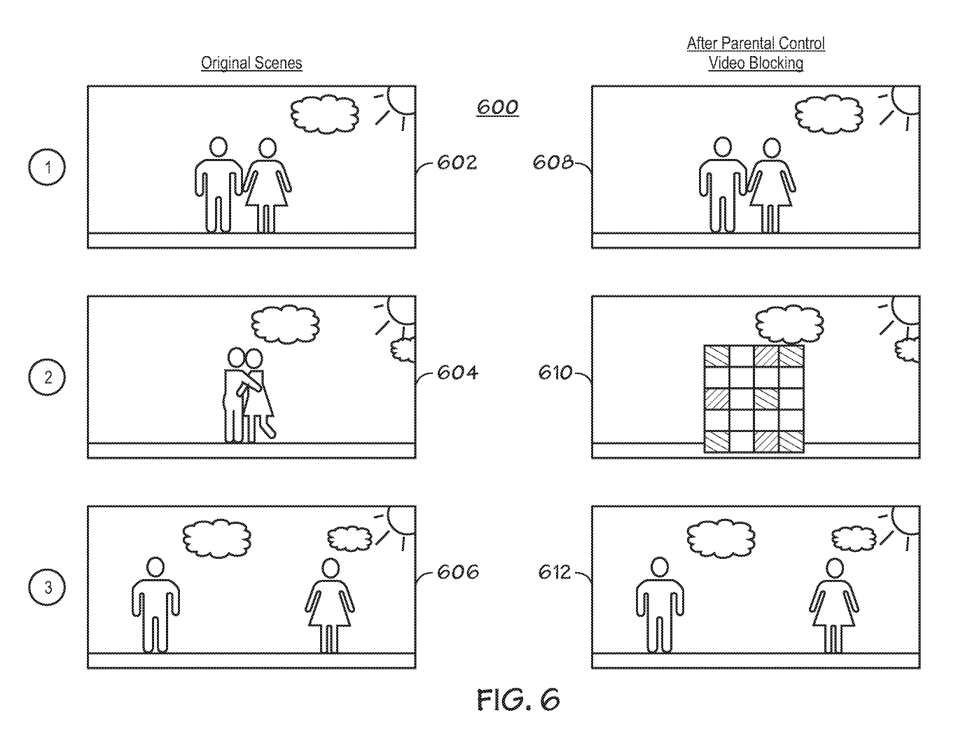

FIG. 6 is a diagram depicting video content before and after the application of light filtering of POC in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Traditional parental control systems do not allow a user to watch an entire television program while blocking only selected types of objectionable visual material from scenes. Exemplary embodiments of the present invention provide a better-tailored parental control system and method. For example, an embodiment of the present invention may allow a user (e.g., a parent) to select a level of filtering to be applied for different types of visual and audible POC that are present in live television programming. Indeed, present embodiments may block a portion of a scene (e.g., a component of video data including nudity that is identified by its coordinates in the scene) in a television program based on indicator data associated with the portion of the scene. Such indicator data may be submitted along with the television program by a broadcaster. The indicator data may mark POC in the program, its specific location on the screen, and corresponding presentation times to facilitate blocking the POC when it occurs.

Blocking may include distorting or completely preventing presentation of audio and/or video output based on the POC in accordance with present embodiments. For example, blocking may include blanking the screen, blanking only a portion of the screen including the POC, various levels of pixilation or blurring of portions of the screen, or various levels of pixilation or blurring of the entire screen during the time associated with the POC. It should be noted that when a portion of a screen is blocked, it may be blocked with any of various shapes, such as a rectangle or a more form-fitting shape. For example, blocking may include pixilation of a very specific area (e.g., every macro-block in the area defined as including POC). Pixilation may include using an average gray level and color of each 8×8 (or other size block) of pixels over an image. In some embodiments, a user may designate the level of pixilation.

FIG. 1 is a block diagram of an electronic device that may employ a parental control system and/or method in accordance with an exemplary embodiment of the present invention. The electronic device is generally indicated by reference numeral 100. The electronic device 100, which may include a television, DVD player, set-top box or the like, comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

Specifically, in the illustrated embodiment, the electronic device 100 includes a signal source input 102, a tuner 104, a processor 106, a memory 108, a parental control logic feature 110, a display 112 and a speaker 114. The signal source input 102 may comprise an antenna input, an RCA input, a cable input, an s-video input, a composite video input or the like. Those of ordinary skill in the art will appreciate that, although only one signal source is shown, the electronic device 100 may have multiple signal source inputs. For example, the electronic device 100 may include a first signal source input that receives a broadcast signal and a second signal source input that receives a stored video signal, such as an input from a DVD player. In an exemplary embodiment of the present invention, the signal source received by the signal source input 102 comprises video data and/or audio data along with POC indicator data, which will be discussed in detail below.

In the illustrated embodiment, the tuner 104 is communicatively coupled with the signal source input 102. The tuner 104 is adapted to tune a particular video program from a broadcast signal received from the signal source input 102. In some embodiments the tuner 104 may be bypassed if the signal source input 102 receives a stored video signal. Indeed, those of ordinary skill in the art will appreciate that input signals that are not received as part of a broadcast spectrum may bypass the tuner 104 because tuning is not required to isolate a video program associated with those signals.

The processor 106 is adapted to control the overall operation of the electronic device 100. Such control may be achieved by the processor 106 when the processor 106 cooperates with the memory 108 to perform operations in accordance with embodiments of the present invention. Specifically, for example, the memory 108 may be associated with the processor 106 such that the memory 108 stores machine-readable computer code that causes the processor 106 to control the operation of the electronic device 100 in a manner in accordance with present embodiments.

The parental control logic feature 110 may include hardware, software or a combination thereof. For example, in one embodiment, the parental control logic feature 110 may include a software program stored in memory (e.g., the memory 108). The parental control logic feature 110 is adapted to receive information regarding one or more particular types of POC to be filtered when video content is displayed. Examples of video POC that may be filtered include sexual content, violence, illegal drug use or the like.

Additionally, the parental control logic feature 110 may receive and store information on a specific filtering level by which to filter each particular type of POC. For example, a user may specify that POC of a sexual nature is to be filtered at a high level, POC depicting violence is to be filtered at a medium level, POC relating to offensive language is to be filtered at a low level, and POC depicting drug use is to not be filtered at all. The level of filtering selected determines the amount of filtering. For example, if a high level of filtering is selected for POC of a violent type, every frame of a scene that includes any violence may be completely hidden (e.g., blocked from display or covered by a warning message). Alternatively, only specific portions of video data (e.g., video data corresponding to a persons mouth when the person is saying an offensive word) may be hidden. In other embodiments, the entire screen or portions of the screen may be pixilated or blurred.

The display 112 of the electronic device 100 is configured to display video data initially received via the signal source input 102. Specifically, the display 112 may only display content initially received via the signal source input 102 and that has been filtered in accordance with present embodiments. The display 112 may comprise a liquid crystal (LCD) display, a liquid-crystal-on-silicon (LCOS) display, a digital light projection (DLP) display or any other suitable display type. The display 112 may include a lighting source (not shown) that is used to facilitate presentation of a visible image on the display.

In an exemplary embodiment of the present invention, the video signal received by the signal source input 102 includes POC indicator data. POC indicator data may be defined as information identifying POC contained in the video by type, associated time of occurrence and by a specific screen location at which the corresponding POC would be displayed. For example, POC indicator data may include an indication that sexual content is present at specific coordinates throughout a scene. The POC indicator data may be inserted into an audio/video (A/V) stream of a transmitter. For an Advanced Television Systems Committee (ATSC) video stream, the time associated with the POC may be indicated by a time stamp that corresponds with the applicable frame or frames. Further, the POC indicator data may be included in a program and system information protocol (PSIP) data packet with an appropriate header identifying it as video parental control data. Such information may be repeated as necessary for proper operation. The POC indicator data may be provided for a group of frames by giving a start time and a stop time of the sequence of POC. In an analog system, the POC indicator data may be inserted as extended data service (XDS) data in blanking intervals of the corresponding video frames.

The POC indicator data may be utilized to block specific data (e.g., video data). For example, if a scene in a television program includes a violent act in the background, the specific coordinates of the video associated with the violent act may be provided in the POC indicator data for each frame of the scene. In addition, the video signal may include information regarding the time of occurrence of each frame of the scene. Accordingly, in an exemplary embodiment, the processor 106 utilizes the POC indicator data to block the display of POC having a type that has been selected for filtering by the user only at the specific screen location on which the POC is set to be displayed. The remainder of the scene (i.e., the portion that does not contain the POC) is displayed to the viewer. In some embodiments, information regarding how long each item of POC is to be displayed may be provided to facilitate blocking the entire scene when a filter setting indicates that such blocking should occur.

The level of filtering applied to a particular type of POC may enlarge the region of the screen that is blocked when a particular type of POC is detected in the input video signal. Examples of filtering levels that may be applied include high filtering, medium filtering and low filtering. For POC associated with a high level of filtering, the blocked screen area indicated in the input video signal may be enlarged by the processor 106 to include up to the entire screen area. For POC associated with medium filtering, a smaller area of the screen, such as the area corresponding to the area indicated in the video signal may be blocked. Further, each of the various filtering levels may employ a different type of blocking. For example, a high level of filtering may be associated with completely hiding or blanking a portion of the screen. Alternatively, for POC associated with low filtering, a video effect may be applied, such as blurring or pixilation to the area of the screen specified in the video input.

FIG. 2 is a process flow diagram in which the display of POC is filtered in a broadcast television scenario in accordance with an exemplary embodiment of the present invention. The method is generally indicated by reference numeral 200. At block 202, the process 200 begins by generating data regarding the type of POC, specific screen area location of the POC and the time at which the POC occurs. The data generated in block 202 may be referred to as POC indicator data. The POC indicator data may be supplied by a broadcaster along with the associated program data. For example, experienced video editors employed by the broadcaster may review programming and identify POC. The identified POC may be associated with a type of POC, mapped to a specific area within a screen or frame, given a rating level and associated with a time of occurrence during the programming. This information may then be utilized to define the POC indicator data, which may be inserted into the broadcast stream along with the other programming information.

At block 204, the POC indicator data is transmitted. For example, block 204 may represent transmitting the POC indicator data in a broadcast signal along with the associated program data. At block 206, data may be entered by a user regarding POC filtering types and levels. In other words, block 206 represents receiving input regarding user-selected filter settings (user settings data). At block 208, the POC indicator data and the user settings data are received. Block 208 may represent isolating the POC indicator data from a bitstream. At block 210, filtering parameters (for example, POC type to be filtered and level of filtering to apply) are determined based upon the user settings data. For example, block 210 may include interpreting answers to user-friendly questions regarding data filtering into actual filter settings or parameters. At block 212, the video content to be displayed is filtered according to the filtering parameters and the associated POC indicator data. At block 214, the filtered video content is displayed. In some exemplary embodiments, the filtered video may be displayed by showing the video corresponding to the received video signal with selected filtering levels and blocking methods being applied to selected POC types. For example, only the screen areas of the display that correspond to the location of user selected types of POC may be affected by the filtering.

FIG. 3 is a process flow diagram in which the display of POC is filtered in a stored media content scenario in accordance with an exemplary embodiment of the present invention. The method is generally indicated by reference numeral 300. At block 302, the process begins by generating data regarding the type of POC, specific screen area location of the POC and the time at which the POC occurs. The data generated in block 302 may be referred to as POC indicator data. The POC indicator data may be supplied by a producer of the stored media along with the associated program data. For example, experienced video editors employed by the producer may review programming and identify POC. The identified POC may be associated with a type of POC, mapped to a specific area within a screen or frame, given a rating level and associated with a time of occurrence during the programming. This information may then be utilized to define the POC indicator data, which may be inserted into the stored media along with the other programming information.

At block 304, the POC indicator data is transmitted. For example, block 304 may represent transmitting the POC indicator data along with the associated program data from a stored video media such as a DVD. At block 306, data may be entered by a user regarding POC filtering types and levels. In other words, block 306 represents receiving input regarding user-selected filter settings (user settings data). At block 308, the POC indicator data and the user settings data are received. Block 308 may represent isolating the POC indicator data from a bitstream. At block 310, filtering parameters (for example, POC type to be filtered and level of filtering to apply) are determined based upon the user settings data. At block 312, the video content to be displayed is filtered according to the filtering parameters and the associated POC indicator data. At block 314, the filtered video content is displayed. In some embodiments, filtered video content is displayed by showing the video corresponding to the received video signal with selected filtering levels being applied to selected POC types. For example, only the screen areas of the display that correspond to the location of user selected types of POC may be affected by the filtering.

FIG. 4 is a diagram depicting video content before and after the application of heavy filtering of POC in accordance with an exemplary embodiment of the present invention. The diagram is generally indicated by reference numeral 400. Blocks 402, 404, and 406 represent three consecutive original (before filtering) display screens of video content. In this exemplary embodiment, block 404 illustrates a display of video content that includes POC of a sexual nature. Blocks 408, 410, and 412 represent three consecutive display screens after the filtering process has occurred. Block 410 represents a display in which the entire display screen was blocked at the time the video content of a sexual nature occurred. If the filtering depicted by block 410 had not occurred, the video content displayed would have been that illustrated by block 404. As set forth above, the heavy level of filtering may include blocking of a display area greater than the area indicated to contain the POC. In the exemplary embodiment shown in FIG. 4, the electronic device 100 (FIG. 1) is programmed so that heavy filtering blocks the entire display screen containing any POC for which heavy filtering is selected. Those of ordinary skill in the art will appreciate that other exemplary heavy filtering options may include blocking an area larger than the area indicated by the video data but less than the entire screen, or just the area indicated by the video data.

FIG. 5 is a diagram depicting video content before and after the application of medium filtering of POC in accordance with an exemplary embodiment of the present invention. The diagram is generally indicated by reference numeral 500. Blocks 502, 504, and 506 represent three consecutive original (before filtering) display screens of video content. In this exemplary embodiment, block 504 illustrates a display of video content that includes POC of a sexual nature. Blocks 508, 510, and 512 represent three consecutive display screens after the filtering process has occurred. Block 510 represents a display in which only the portion of the display screen where the POC was located was blocked at the time the video content of a sexual nature occurred. If the filtering depicted by block 510 had not occurred, the video content displayed would have been that illustrated by block 504. As set forth above, the medium level of filtering may include blocking of a display area equal to the area where the POC is located. In the exemplary embodiment shown in FIG. 5, the electronic device 100 (FIG. 1) is programmed so that medium filtering blocks only the portion of the display screen containing any POC for which medium filtering is selected. Those of ordinary skill in the art will appreciate that other exemplary medium filtering options may include blocking an area smaller than the area indicated by the video data.

FIG. 6 is a diagram depicting video content before and after the application of light filtering of POC in accordance with an exemplary embodiment of the present invention. The diagram is generally indicated by reference numeral 600. Blocks 602, 604, and 606 represent three consecutive original (before filtering) display screens of video content. In this exemplary embodiment, block 604 illustrates a display of video content that includes POC of a sexual nature. Blocks 608, 610, and 612 represent three consecutive display screens after the filtering process has occurred. Block 610 represents a display in which only the portion of the display screen where the POC was located was pixilated at the time the video content of a sexual nature occurred. If the filtering depicted by block 610 had not occurred, the video content displayed would have been that illustrated by block 604. As set forth above, the light level of filtering may include pixilating of a display area equal to the area indicated to contain the POC. In the exemplary embodiment shown in FIG. 6, the electronic device 100 (FIG. 1) is programmed so that light filtering pixilates only the portion of the display screen containing any POC for which light filtering is selected. Those of ordinary skill in the art will appreciate that other exemplary light filtering options may include pixilating an area smaller than the area indicated by the video data.

While embodiments of the present invention may be susceptible to various modifications and alternative forms, specific embodiments have been shown by way of example in the drawings and will be described in detail herein. However, it should be understood that embodiments of the invention are not intended to be limited to the particular forms disclosed. Rather, embodiments of the invention are to cover all modifications, equivalents and alternatives falling within the spirit and scope of embodiments of the invention as defined by the following appended claims.

1. A method of displaying video content, comprising:
receiving input regarding a type of POC that is to be filtered when displaying the video content;
receiving a video signal containing an indication of a display location of POC in the video content and a type of POC at that display location; and
filtering display of content identified by the indication of the display location of the POC and the type of the POC if the type of POC corresponds to the type of POC that is to be filtered when displaying the video content.

2. The method recited in claim 1, wherein the video signal contains an indication with respect to a time at which POC will be displayed.

3. The method recited in claim 2, comprising blocking the display of the POC identified by the time at which the POC will be displayed if the type of POC identified in the signal corresponds to the type of POC that is to be filtered when displaying the video content.

4. The method recited in claim 1, comprising receiving input regarding a filtering level of POC that is to be filtered when displaying the video content.

5. The method recited in claim 4, wherein options associated with the filtering level comprise:
blocking or blurring an area of a display screen larger than the indication of the display location of the POC; or
blocking or blurring an area of the display screen equal to the indication of the display location of the POC.

6. The method recited in claim 4, wherein the filtering level comprises heavy filtering, medium filtering or light filtering.

7. The method recited in claim 6, comprising filtering an area larger than the indication of the display location of the POC if the filtering level comprises heavy filtering.

8. The method recited in claim 6, comprising filtering an area equal to the indication of the display location of the POC if the filtering level comprises medium filtering.

9. The method recited in claim 6, wherein filtering display of content comprises blurring an area equal to the indication of the display location of the POC if the filtering level comprises light filtering.

10. An electronic device that is adapted to display video content, comprising:
a display;
a signal source input that is configured to receive a video signal containing POC indicator data indicative of a type and a screen location of POC configured for presentation on the display;
a parental control logic that is configured to receive input regarding a type of POC that is to be filtered; and
a processor that is configured to block POC configured for presentation on the display from being presented at the screen location if the type of POC that is configured to be displayed is the same as the type of POC that is to be filtered.

11. The electronic device recited in claim 10, wherein the video signal contains an indication with respect to a time at which POC will be displayed.

12. The electronic device recited in claim 10, wherein the processor is adapted to display filtered video content by:
blocking the entire display screen at the time the POC would be displayed; or
blocking a portion of the display screen at the time the POC would be displayed.

13. The electronic device recited in claim 10, comprising a processor that is configured to display filtered video content by:
pixilating the entire display screen at the time the POC would be displayed; or
pixilating a portion of the display screen at the time the POC would be displayed.

14. The electronic device recited in claim 10, wherein the processor is adapted to receive input regarding a filtering level of POC that is to be filtered when displaying the video content.

15. The electronic device recited in claim 14, wherein options associated with the filtering level comprise:
blocking or blurring an area of a display screen larger than the screen location of the POC; or
blocking or blurring an area of the display screen equal to the screen location of the POC.

16. The electronic device recited in claim 14, wherein the filtering level comprises heavy filtering, medium filtering or light filtering.

17. The electronic device recited in claim 16, comprising filtering an area larger than the screen location of the POC if the filtering level comprises heavy filtering.

18. The electronic device recited in claim 16, comprising filtering an area equal to the screen location of the POC if the filtering level comprises medium filtering.

19. The electronic device recited in claim 16 wherein filtering display of content comprises blurring an area equal to the screen location of the POC if the filtering level comprises light filtering.

20. An electronic device that is adapted to display video content, the electronic device comprising:
means for receiving input regarding a type of potentially POC that is to be filtered when displaying the video content;
display location of POC in the video content and a type of POC at that display location; and
means for filtering display of content identified by the indication of the display location of the POC and the type of the POC if the type of POC corresponds to the type of POC that is to be filtered when displaying the video content.
